(19) United States
(12) Patent Application Publication
(10) Pub. No.: US 2017/0331844 A1
(43) Pub. Date: Nov. 16, 2017

(54) SYSTEMS AND METHODS FOR ASSESSING AIRFRAME HEALTH

(71) Applicant: Sikorsky Aircraft Corporation, Stratford, CT (US)

(72) Inventors: Matthew Harrigan, Horseheads, NY (US); Theodore Meyer, Pavilion, NY (US); Garrett Argenna, Rochester, NY (US); Avinash Sarlashkar, Pittsford, NY (US)

(21) Appl. No.: 15/481,233

(22) Filed: Apr. 6, 2017

Related U.S. Application Data
(60) Provisional application No. 62/336,057, filed on May 13, 2016.

(51) Int. Cl. H04L 29/06; G06N 99/00; B64D 45/00

(52) U.S. Cl. CPC H04L 63/1425; G06N 99/005; B64D 45/00; B64D 2045/0085; H04L 63/1416

(57) ABSTRACT

A method of assessing structural health includes receiving an anomaly detector, receiving an anomaly detection threshold, and receiving a strain measurement for a structure of interest. A rating is generated for the strain measurement using the anomaly detector and compared with the anomaly detection threshold. Health of the structure of interest is determined based on the comparison of the rating and the anomaly detection threshold.

### CROSS-REFERENCE TO RELATED APPLICATION

This application claims the benefit of priority under 35 U.S.C. §119(e) to U.S. Provisional Application No. 62/336,057, filed May 13, 2016, which is incorporated herein by reference in its entirety.

### FEDERAL RESEARCH STATEMENT

This invention was made with government support with the United States Army under Contract No. W911W6-13-2-0006. The government has certain rights in the invention.

### BACKGROUND OF THE INVENTION

### 1. Field of the Invention

The present disclosure relates to aircraft health monitoring, and more particularly to assessing the structural health of airframes in rotorcraft.

### 2. Description of Related Art

Aerospace vehicles, such as airplanes and helicopters, may face sources of potential damage such as from flight loads, ground loads, the external environment and non-deterministic sources such as foreign object debris (FOD) or other items that can cause damage by impacting or striking the vehicle. Rotorcraft flight loads can be complex due to the unique propulsion, rotor, and drive systems and the associated aerodynamic and vibration characteristics that produce extremely large numbers of fatigue loading cycles. The damage sources can stress and damage the structure of the vehicle, leading to expensive repairs or safety concerns.

One approach to such potential damage is manual inspection of airframe structure. Manual inspections typically involve visually inspecting airframe components for damage and either finding an indication of damage or not finding an indication of damage. Such inspections can have significant cost and negatively impact aircraft availability and typically do not provide information relating the damage indication to structure health and/or flight safety.

Such conventional methods and systems have generally been considered satisfactory for their intended purpose. However, there is still a need in the art for improved systems and methods assessing airframe health. The present disclosure provides a solution for this need.

### SUMMARY OF THE INVENTION

A method of assessing structural health includes receiving an anomaly detector, receiving an anomaly detection threshold, and receiving a strain measurement for a structure of interest. A rating is generated for the strain measurement using the anomaly detector and compared with the anomaly detection threshold. Health of the structure of interest is determined based on the comparison of the rating and the anomaly detection threshold.

In certain embodiments, the method can include providing to a user interface a repair/safe to fly determination based on the comparison. The strain measurement can be acquired using a sensor connected to the airframe of interest. The strain measurement can be associated with a load on the airframe and/or an aircraft state at the time the strain measurement was acquired. A detection threshold can be determined using the structurally healthy airframe strain measurements.

In accordance with certain embodiments, the strain measurements from the structurally healthy airframes can be used to build anomaly detector using airframe load and/or aircraft state. The strain measurements from the structurally healthy airframes can be used to build the anomaly detector using an unsupervised machine learning algorithm. The anomaly detection threshold can be associated with the anomaly detector built from the strain measurements from the structurally healthy airframes. The anomaly detection threshold can be based on statistical proximity of the strain measurement from a prediction of strain indicated by the anomaly detector.

It is also contemplated that, in accordance with certain embodiments, the method can include training an anomaly detection module. Training the anomaly detection module can include receiving a strain measurement training data set and determining an anomaly detection threshold. Training the anomaly detection module can include receiving airframe load data in association with the strain measurement training data set. Training the anomaly detection module can include receiving aircraft state and/or flight regime data in association with the strain measurement training data. An anomaly detection threshold can be determined for application to the statistical proximity of a strain measurement from an airframe of interest from a prediction of strain indicated by the anomaly detection module.

An airframe health assessment system includes a strain sensor configured to acquire strain measurements from an airframe of interest and an anomaly detection module communicative with sensor. The anomaly detection module is configured to execute machine-readable instructions that cause the system to receive a strain measurement from the strain sensor indicative of strain on the airframe of interest. The anomaly detection module is configured to execute machine-readable instructions that cause the system to receive strain measurements from structurally healthy airframes.

In certain embodiments, the instructions can cause the system to determine statistical proximity of the strain measurement to a prediction of strain response. The instructions can cause the system to provide a repair/safe to fly determination to a user interface communicative with the anomaly detection module. The instructions can cause the system to determine an anomaly detection threshold for a new strain measurement acquired from the airframe of interest, and the proximity of the strain measurement to the prediction of strain response can be compared using the anomaly detection threshold.

In certain embodiments, the system can include an unsupervised machine learning module communicative with the anomaly detection module. The unsupervised machine learning module can be responsive to machine-readable instructions to train the anomaly detector using strain measurements from structurally healthy airframes by airframe load and aircraft state using an unsupervised machine learning algorithm.

In accordance with certain embodiments, the anomaly detection module can be trained using data from structurally healthy airframes. In this respect the anomaly detection module can receive a strain measurement training data set, receive a load training data set having loads associated measurements of the strain measurement training data set, receive a state parameter data set having aircraft states associated with strain measurements of the strain measurement training data set, cluster the strain measurements by airframe load and aircraft state in N-dimensional space using a Gaussian Mixture Model, and define anomaly detecting thresholds using the anomaly detection module.

These and other features of the systems and methods of the subject disclosure will become more readily apparent to those skilled in the art from the following detailed description of the preferred embodiments taken in conjunction with the drawings.

### BRIEF DESCRIPTION OF THE DRAWINGS

So that those skilled in the art to which the subject disclosure appertains will readily understand how to make and use the devices and methods of the subject disclosure without undue experimentation, embodiments thereof will be described in detail herein below with reference to certain figures, wherein:

FIG. 1 is a schematic view of an exemplary structural diagnostic system, showing the structural diagnostic system receiving data from a structure of interest and data from healthy structures for assessing the health of the structure of interest;

FIG. 2 illustrates operation of the structural diagnostic system of FIG. 1, showing strain data from healthy structures being used to train an anomaly detector and the trained anomaly detector comparing strain data from the airframe of interest to generate healthy/unhealthy output based on the comparison;

FIG. 3 illustrates a process flow for training the anomaly detector of FIG. 2 and generating anomaly detection thresholds using data from healthy structures; and

FIG. 4 illustrates a process flow for assessing health of a structure of interest using the trained anomaly detector and the anomaly detection threshold.

### DETAILED DESCRIPTION OF THE PREFERRED EMBODIMENTS

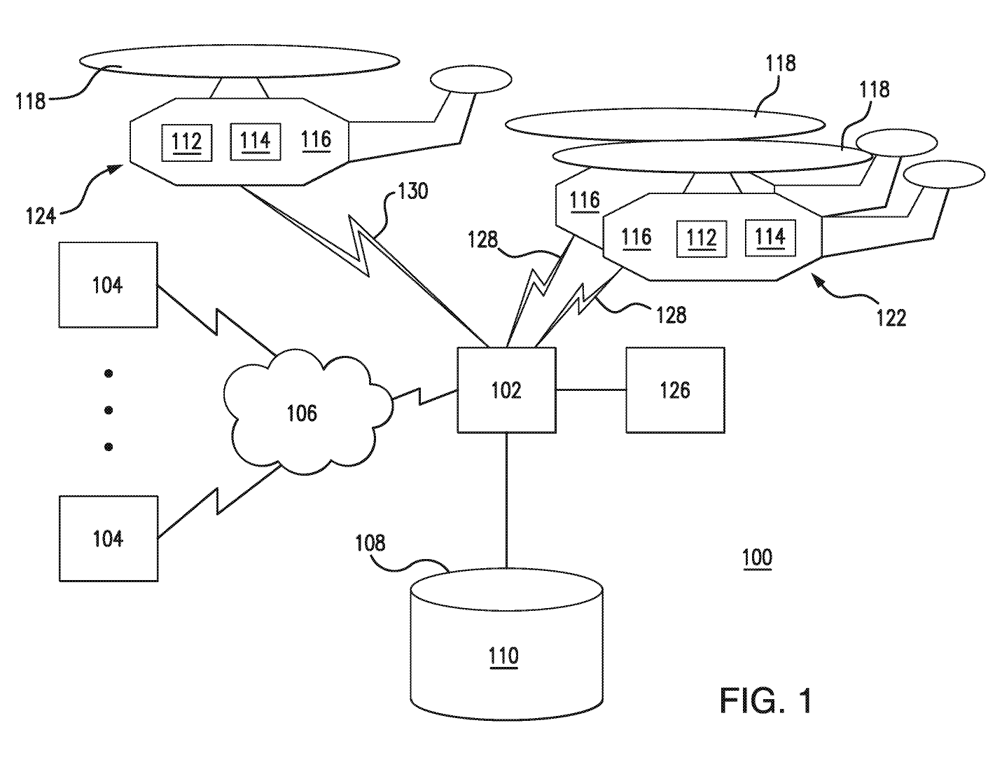

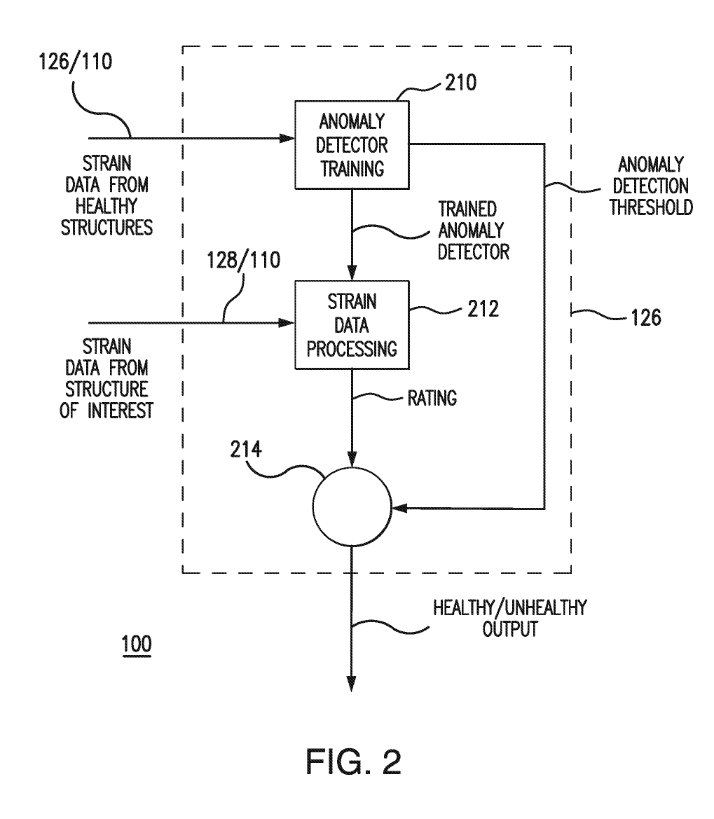

Reference will now be made to the drawings wherein like reference numerals identify similar structural features or aspects of the subject disclosure. For purposes of explanation and illustration, and not limitation, a partial view of an exemplary embodiment of an airframe health assessment system in accordance with the disclosure is shown in FIG. 1 and is designated generally by reference character 100. Other embodiments of airframe health assessment systems and methods of assessing airframe health in accordance with the disclosure, or aspects thereof, are provided in FIGS. 2-4, as will be described. The systems and methods described herein can be used assessing the health of rotorcraft airframes, however the invention is not limited to rotorcraft airframes or to aircraft in general.

As indicated above, because of the sheer number of possible structural fault conditions, in most cases it is impractical to install specialized sensors dedicated to detecting and isolating every single fault condition on a vehicle. Thus, what is needed is a system, method, and/or computer program product configured to optimally utilize vehicle strain measurements to detect anomalous responses to loads while adequately compensating for the normal variation in strain responses induced by changes in vehicle load and operating state. Detection of an anomalous strain response can trigger thereafter a fault detection and isolation investigation for a given vehicle.

In general, embodiments of the present invention disclosed herein may include a structural anomalous response detection system, method, and/or computer program product (“structural diagnostic system”) that detects, computes, and analyzes sensor data that results in the detection of abnormal structural responses. The presence of abnormal strain responses can be indicative of changes in static or dynamic characteristics (e.g., stress, strain, pressure, displacement, acceleration, vibration) of structural elements responsive to loads encountered by a vehicle (e.g., an aircraft) and/or dynamic components thereof. Vehicle operation results in certain responses, which may be structural or mechanical loads or other measurable responses as a result of these loads. As used in this specification, the term “load” will be used as a surrogate for all vehicle responses, including structural or mechanical loads themselves (e.g., mechanical loads, electromechanical loads, electromagnetic loads, etc.) as well as other vehicle responses (e.g., structural/mechanical responses, electromechanical responses, electromagnetic responses, optical responses, etc.) to a load; thus load signals may indicate, for example, force, moment, torque, stress, strain, current, and/or voltage. Strain responses at a given structural location to a load are characteristic of a particular vehicle design. The nominal (e.g., healthy) strain response to the load is also strongly influenced by the operating state of the vehicle.

It is impractical to equip a vehicle, such as an aircraft, deployed for field use with load sensors on all structural elements, as there is substantial material and labor cost associated with the installation and maintenance of load sensors. Further, the addition of sensors and wiring to convey sensor signals adds weight to the aircraft. Furthermore, the durability of conventional sensors for load measurement may be limited. Thus, virtual load monitoring of sensor data can be performed to estimate dynamic signals according to a plurality of models. To estimate loads, sensor data from a given component is input, along with measured operational state parameters and measured loads, into structural anomaly detection logic. Physics-based models can be used to predict strains and identify anomalous responses remote from the location of an estimated load.

The structural anomaly detection logic may perform virtual monitoring of aircraft structural loads in real-time onboard or remote to the aircraft. The real-time virtual monitoring physics-based modeling can leverage real-time sensor data and estimated structural loads, which compensate for the normal variation in loads, to detect and isolate faults. Anomaly detection may be triggered based on certain events, such as commencement of a flight maneuver anticipated to produce high structural loads. Virtual monitoring of loads is typically performed in real time using empirical models as well as physics-based modeling, each of includes estimated datum relative to components of the aircraft. Fault detection and isolation can follow anomaly detection.

Referring to FIG. 1, an example of a structural diagnostic system 100 for detecting anomalous strain responses to vehicles loads (herein discussed with respect to an aircraft) is shown. Structural diagnostic system 100 includes a computing subsystem 102 in communication with remote sub-systems 104 over a network 106. Computing sub-system 102 is also communicative with a database 108 to read and write data 110 in response to requests from remote sub-systems 104.

Computing sub-system 102 is a computing device (e.g., a mainframe computer, a desktop computer, a laptop computer, or the like) including at least one processing circuit (e.g., a CPU) capable of reading and executing instructions stored on a memory therein, and handling numerous interaction requests form remote sub-system 104. Computing subsystem 102 may also represent a group of computer systems collectively performing structural anomaly-detection processes as described in greater detail herein. Remote sub-systems 104 can also comprise a desktop, laptop, general-purpose computer devices, and/or networked devices with processing circuits and input/output interfaces, such as a keyboard and display device.

Computing sub-system 102 and/or remote sub-systems 104 are configured to provide a structural anomaly detection process, where a processor may receive computer readable program instructions from a structural anomaly-detection logic of the memory and execute these instructions, thereby performing one or more processes defined by the anomaly-detection logic. The processor may include any processing hardware, software, or combination of hardware and software utilized by computing sub-system 102 and/or remote sub-systems 104 that carries out the computer readable program instructions by performing arithmetical, logical, and/or input/output operations. The memory may include a tangible device that retains and stores computer readable program instructions, as provided by the anomaly detection logic, for use by the processor of the computing sub-system 102 and/or remote sub-systems 104. Computing sub-system 102 and/or remote sub-systems 104 can include various computer hardware and software technology, such as one or more processing units or circuits, volatile and non-volatile memory including removable media, power supplies, network interfaces, support circuitry, operating systems, user interfaces, and the like. Remote users can initiate various tasks locally on the remote sub-systems 104, such as requesting data from computing sub-system 102 via secure clients.

Network 106 may be any type of communications network, including a local area network (LAN) or a wide area network (WAN), or the connection may be made to an external computer (for example, through the Internet using an Internet Service Provider). For example a network may be the Internet, a LAN, a WAN and/or a wireless network, comprise copper transmission cables, optical transmission fibers, wireless transmissions, routers, firewalls, switches, gateway computers and/or edge servers, and may utilize a plurality of communication technologies, such as radio technologies, cellular technologies, etc.

Database 108 may include one or more databases, data repositories, or other data stores and may include various kinds of mechanisms for storing, accessing, and retrieving various kinds of data, including a hierarchical database, a set of files in a file system, an application database in a proprietary format, a relational database management system, etc. Data 110 of database 108 can include empirical models, physical-based models, sensed data, anomaly detectors, anomaly detection thresholds, etc.

Computing sub-system 102 and/or remote sub-systems 104 are also configured to communicate with an aircraft fleet 122 via one or more communication links 128 and 130. Aircraft fleet 122 can include a variety of aircraft 116, such as fixed-wing and/or rotorcraft. Communication links 128 and 130 can be wireless, satellite, or other communication links. Communication links 128 and 130 may also support wired and/or optical communication when aircraft 116 are on the ground and within physical proximity to computing sub-system 102. In exemplary embodiments, computing sub-system 102 and other components of structural diagnostic system 100 may be either ground-based and/or integral with aircraft 116, such that the structural diagnostic system 100 reliably and automatically measures sensor data to detect anomalous strain responses, while compensating for normal variation in strain responses among structurally healthy aircraft. Further, in exemplary embodiments, aircraft fleet 122 transmits flight data to computing sub-system 102 for anomalous strain detection.

In the example depicted in FIG. 1, each aircraft 116 is a rotorcraft with a main rotor 118 capable of revolving at a sufficient velocity to sustain flight. Aircraft 116 also includes a monitoring sub-system 112 configured to receive sensor data, such as combinations of low-frequency state parametric data and high-frequency state parametric data, from one or more sensors 114 (e.g., strain sensors).

Monitoring sub-system 112 with sensors 114 are communicatively coupled and may be incorporated with or external to each other. During rotorcraft operation, the sensor data is acquired by monitoring sub-system 112 from sensors 114, and is supplied to other elements of structural diagnostic system 100. Also, during operation of monitoring sub-system 112, measured state parameters and measured loads of aircraft 116 are acquired by structural diagnostic system 100. The sensor data obtained by structural diagnostic system 100 provides diagnostic information for one or more empirical models and physics-based models about various components of aircraft 116, which may then be used to detect anomalous strain responses in the component(s).

Sensors 114 are converters that measure physical quantities and convert the physical quantities into a signal (e.g., sensor data) that is acquired by monitoring sub-system 112, and in turn structural diagnostic system 100. In one embodiment, sensors 114 are strain gauges that measure the physical change to a component of aircraft 116 (e.g., an airframe structural element, etc.). Examples of strain gauges include fiber optic gauges, foil gauges, capacitive gauges, etc. In another embodiment, sensors 114 are temperature sensors that measure the temperature characteristics and/or the physical change in temperature of an aircraft component. Examples of temperature sensors include fiber optic nano-temperature sensors, heat meters, infrared thermometers, liquid crystal thermometers, resistance thermometers, temperature strips, thermistors, thermocouples, and the like. In any of the embodiments, one or more of sensors 114 may be located within a housing to provide protection for the sensor from material that could otherwise damage or degrade the sensor.

Furthermore, sensors 114 are representative of a plurality of sensors monitoring different locations and portions of each aircraft 116 with respect to different loads (e.g., a first sensor may be located on a main rotor shaft to detect a main rotor torque, a second sensor may be located on an airframe element to detect strain at an airframe location associated with respect to the rotor shaft, a third sensor may be located on a bearing to detect loads on the bearing, etc.). In an exemplary embodiment one or more sensors are positioned on a load-carrying member such a frame or rib of an airframe component, which may be a composite structure. Irrespective of the precise location, the sensors 114 can also be positioned in different orientations so that different directional loads (e.g., forces) or responses can be detected.

In addition to the above, monitoring sub-system 112 includes an anomaly-detection module 126 (e.g., anomaly-detection logic) comprising computer readable program instructions configured to process at least the sensor data, such as in accordance with user inputs instructing anomaly-detection module 126 to operate in a particular manner. Anomaly-detection module 126 is therefore capable of computing and analyzing sensor data as detected and outputted by monitoring sub-system 112 and sensors 114 on each aircraft 116. One or more of aircraft may be designated as having a structure of interest, generally indicated with arrow 124, which may be an airframe or composite airframe element.

For example, FIG. 2 illustrates a process flow within anomaly-detection module 126 of structural diagnostic system 100. As illustrated in FIG. 2, data 110 that includes aircraft state parameters, strain data from structurally healthy aircraft, empirical models, and physics-based models is received by anomaly-detection module 126 and processed at block 210 to create one or more anomaly detectors and one or more anomaly detection thresholds associated with the anomaly detector(s) (e.g., the aircraft state parameters and strain measurements used to train an anomaly detection module using an unsupervised machine learning algorithm). The detection threshold may be considered an expected value for corresponding sensor data. Next, sensor data is received from an aircraft of interest from monitoring sub-system 112 via communication links 128 and 130, and then processed at block 212 to produce sensed strain data. At comparison block 214 (illustrated with a circle), a comparison is made between the sensed strain data from the aircraft of interest and the anomaly detection threshold to produce a distance between the sensed strain data and the anomaly detection threshold. For example, an unsupervised machine learning algorithm may be used to develop a model which characterizes the behavioral patterns of a healthy structure, and applied at comparison block 214 to compute a score of novelty on received strain data from an aircraft of interest. In this way combinations of strains, loads, and aircraft state parameters are processed using an unsupervised machine learning algorithm trained using data from healthy aircraft spanning the expected range of field conditions, and subsequent data from an aircraft of interest is classified as novel (i.e. different than expected). In an exemplary embodiment, a Gaussian Mixture Model is trained using the data from healthy aircraft spanning the expected range of field conditions, and data from an aircraft of interest is classified as novel (e.g., healthy or unhealthy) based on distance from clusters of healthy data in a statistical sense.

At comparison block 214, the novelty of the subsequent strain measurement is analyzed by a decision model to determine whether the structure of the aircraft of interest is healthy. That is, if subsequently received strain measurement is within an anomaly detection threshold, then the decision modeling may determine that the corresponding component of the aircraft is responding as expected (e.g., since the sensed strain measurement is within the anomaly detection threshold). Further, if the sensed strain measurement is outside of the anomaly detection threshold, then the decision modeling may determine that the corresponding component of the aircraft is trending towards failure. For example, if the difference or delta between the sensed strain measurement and the anomaly detection threshold does not exceed a predetermined amount, then the sensed variation can be deemed acceptable. Whereas, if the difference or delta between the sensed strain measurement and the anomaly detection threshold exceeds the predetermined amount, maintenance action may be required. Thus, a singular value reflects the novelty of a new strain measurement relative what has been seen in healthy data.

While single items are illustrated for anomaly-detection module 126 (and other items by each Figure), these representations are not intended to be limiting and thus, anomaly-detection module 126 items may represent a plurality of applications. For example, multiple structural anomaly detection applications in different geographic locations may be utilized to access the collected information, and in turn those same applications may be used for on-demand data retrieval. In addition, although one breakdown or instance of anomaly-detection module 126 is offered, it should be understood that the same operability may be provided using fewer, greater, or differently named modules.

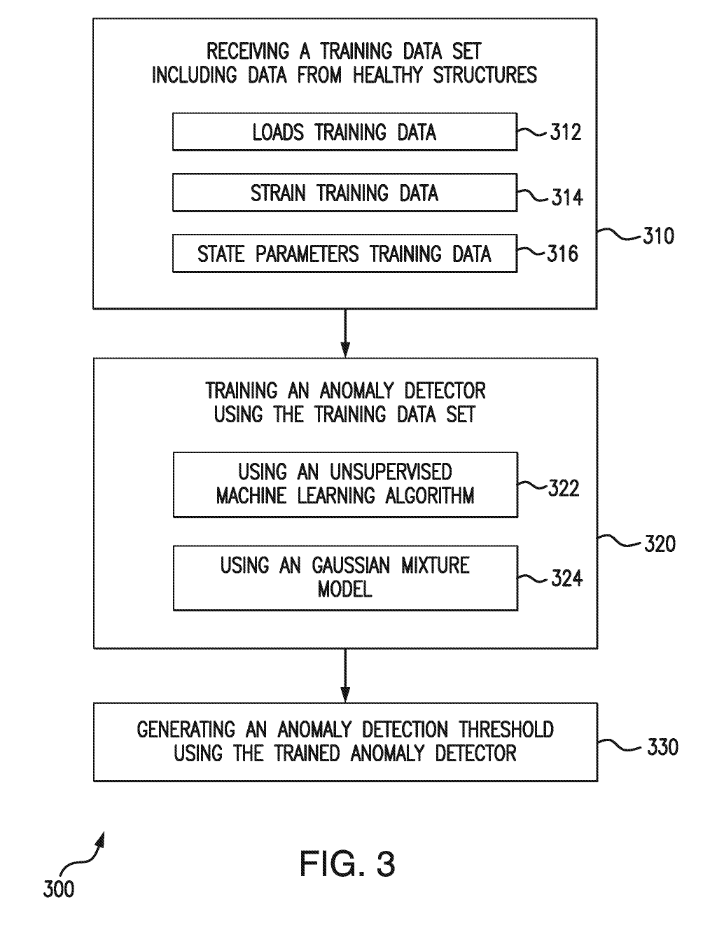

In view of the above, the structural diagnostic system 100 and elements therein illustrated in FIG. 1 (and the other figures) may take many different forms and include multiple and/or alternate components and facilities. That is, while aircraft 116 is shown in FIG. 1, the components illustrated in FIG. 1 and the other Figures are not intended to be limiting. Indeed, additional or alternative components and/or implementations may be used. For instance, monitoring sub-system 112 and the sensors 114 may include and/or employ any number and combination of sensors, computing devices, and networks utilizing various communication technologies that enable structural diagnostic system 100 to perform the anomaly detection process, as further described with respect to FIG. 3.

FIG. 3 illustrates a method 300 of training an anomaly detection module, e.g., anomaly detector training block 210 (shown in FIG. 2). Training the anomaly detection module includes receiving a strain measurement training data set, as shown with box 310. The training data includes one or more of a loads training data set (shown with box 312), a strains training data set (shown with box 314), and a state parameters training data set (shown with box 316). For example, airframe loads can be received in association with the strain measurement training data set as a loads training data set. Aircraft state and/or flight regime data can be received in association with the strain measurement training data as the strains training data set.

Anomaly-detection module 126 (shown in FIG. 1) is trained using the received training data set, as shown with box 320. In this respect the received training data is used to develop a characterization of the behavioral patterns of healthy structures, e.g., aircraft fleet 122 (shown in FIG. 1), for purposes of subsequently computing a score of novelty of subsequently received data from a structure of interest, e.g., aircraft structure of interest 124 (shown in FIG. 1). The model is developed using an unsupervised machine learning algorithm, as shown with box 322. In certain embodiments the unsupervised machine learning algorithm is a Gaussian Mixture Model, as shown with box 324, which clusters healthy strain data according to loads and aircraft flight regimes. As will be appreciated by those of skill in the art in view of the present disclosure, use of an unsupervised machine learning model avoids the need to employ a supervised classifier, which can require relative large amounts of data acquired from aircraft with particular types of faults.

The output of the unsupervised machine learning model can be a unit-less value that is associated with the degree of similarity of new strain measurements from the structure or airframe of interest with the healthy measurements from which the model was developed. In certain embodiments, the output may be a statistical measure of proximity to healthy strain measurements. Accordingly, based on the anomaly detector prediction of healthy performance (e.g., strain response to a given load/flight regime), an anomaly detection threshold is determined, as shown with box 330. The anomaly detection threshold converts the output from the unsupervised machine learning model into an actionable, Boolean, indicative of damage and/or recommending a selection from amount a predetermined set of finite responses. It is contemplated that the anomaly detection threshold be chosen by (a) selecting a detection threshold which offers a desired minimal false alarm rate on the healthy training data, (b) acquiring additional healthy aircraft data from the aircraft of interest and choosing an anomaly detection threshold which offers a desired minimal false alarm rate on the data from the aircraft of interest, or (c) acquiring additional healthy and non-healthy aircraft data from the aircraft of interest and choosing an anomaly detection threshold which offers a desired minimal false alarm rate and minimal miss-detect rate on the data from the aircraft of interest.

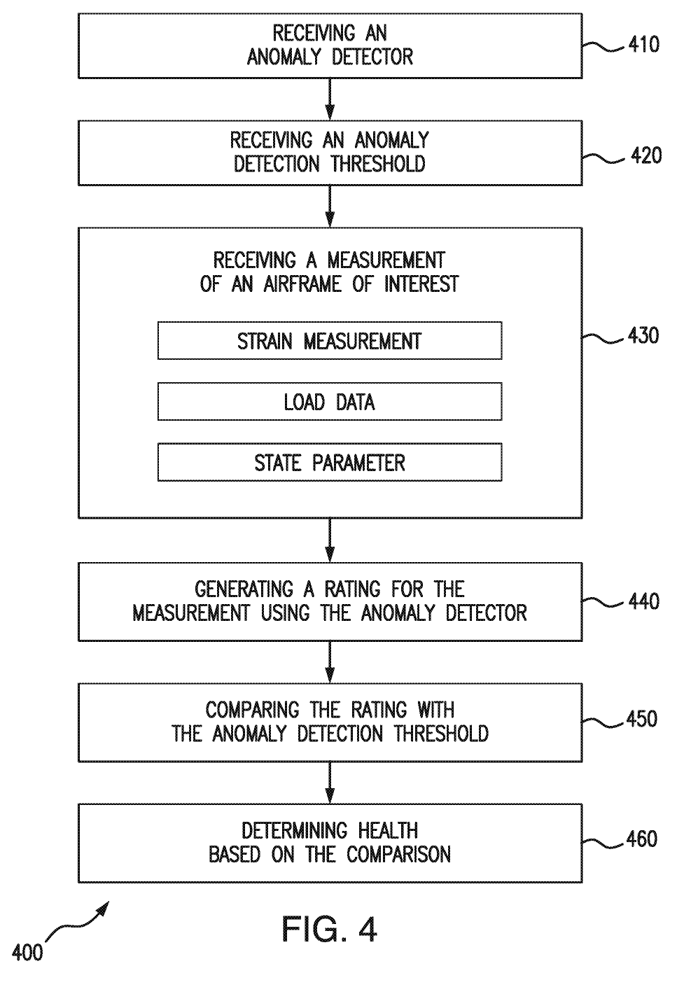

With reference to FIG. 4, a method 400 of assessing structural health generally includes receiving the anomaly detector (shown with box 410), receiving an anomaly detection threshold (shown with box 420), and receiving a strain measurement for a structure of interest (shown with box 430). A rating is generated for the strain measurement using the anomaly detector, as shown with box 440, and the rating is compared with the anomaly detection threshold, as shown with box 450. Health of the structure of interest is determined based on the comparison of the rating and the anomaly detection threshold, as shown with box 460.

Rotorcraft airframes generally respond to the various forces and load exerted on the airframe during operation. The responses can generally be detected with sensors, potentially allowing for detection and isolation of faults associated with the forces and loads. However, because of the sheer number of possible structural fault conditions, it is impractical to install specialized sensors to every airframe location where damage can occur. Moreover, the data describing the universe of possible faults for a given airframe would necessarily be infinite, which typically is not possible using conventional computer-based methods of fault detection and isolation techniques, which have limitations. For that reason aircraft typically undergo cyclic and/or event driven manual inspections, usually entailing involving visual or ultrasonic techniques, which report whether indication of airframe damage was found or was not found. While generally satisfactory, particularly with respect to dynamic systems having a discrete number of components and potential faults, such inspection reports generally do not provide information of how indication of damage on a given airframe affects the structural health or safety of flight aircraft having the indication of airframe damage.

One approach to the challenges of detecting and isolating airframe faults is the use of supervised learning techniques. Supervised learning generally involves collecting relatively large amounts of training data for various faulty conditions and applying algorithms to the data to determine what is faulty and what is healthy. Acquiring the data necessary for such supervised learning techniques is generally relatively expensive and typically is applicable to a limited number of faults as it is necessary to identify an airframe with a specific fault, collect data including information illustrating the fault, and develop an algorithm to recognize the fault. In embodiments described herein, unsupervised learning is applied to structure or airframe data. The unsupervised learning is based on information from healthy structures or airframes, which is generally more readily available as most rotorcraft airframes are generally in a healthy condition most of the time. The unsupervised learning technique predicts global loads acting on a given airframe, and applies physics-based models to predict strains at locations in the airframe remote from an estimated load applied to the airframe. In certain embodiments, historical responses of an airframe of interest at a sensed location are used to predict strain at the sensed location in response to a given load. The historical responses may be in association with the flight regime of the aircraft at the time one or more of the historical responses was acquired.

In accordance with certain embodiments, an anomaly-detection module uses the healthy training data to develop an anomaly detector that characterizes the behavior patterns of the healthy structure, and then scores the novelty of ‘new’ data acquired from the structure or airframe of interest. Characterization may include clustering airframe strain measurements, airframe loads, and aircraft state parameters. Strain measurements from the airframe or other structures of interest may be compared to the clustered strain measurements from the structurally healthy airframes, and a determination is made of the health of the airframe or other structure of interest based on whether the comparison indicates that the measurements are novel relative to the clustered strain measurements.

In certain embodiments, clustering can be done using an unsupervised machine learning algorithm, such as a Gaussian Mixture Model, and the measurements grouped as one or more clusters in N-dimensional space. In accordance with certain embodiments, determination is made of whether a given strain measurement from an airframe or other structure of interest is classified as novel, e.g., different than expected, based a relationship of the strain measurement to the one or more clusters in a statistical sense. It is contemplated that the determination can be made autonomously, thereby assessing the likelihood of airframe or structure damage based on measured structural strains and estimated flight loads. The determination can allow for repair/safety of flight decisions to be made based on quantifiable effects of airframe or structure damage rather than presentation of damage indicia in an airframe of interest.

The methods and systems of the present disclosure, as described above and shown in the drawings, provide for airframe or other structure health assessment systems and methods with superior properties including, for example, the ability to distinguish damaged airframes that are safe to fly from damaged airframes that require repair. While the apparatus and methods of the subject disclosure have been shown and described with reference to preferred embodiments, those skilled in the art will readily appreciate that changes and/or modifications may be made thereto without departing from the scope of the subject disclosure.

What is claimed is:

1. A method of assessing structural health, comprising:
receiving an anomaly detector;
receiving an anomaly detection threshold;
receiving a strain measurement for a structure of interest;
generating a rating for the strain measurement using the anomaly detector;
comparing the rating with the anomaly detection threshold; and
determining health of the structure of interest based on the comparison of the rating and the anomaly detection threshold.

2. The method as recited in claim 1, further comprising training the anomaly detector using a strain measurement training set acquired from a plurality of healthy structures.

3. The method as recited in claim 1, further comprising training the anomaly detector using a loads training data set acquired from a plurality of healthy structures.

4. The method as recited in claim 1, further comprising training the anomaly detector using a state parameters training data set acquired from a plurality of healthy structures.

5. The method as recited in claim 1, further comprising training the anomaly detector using an unsupervised machine learning algorithm and one or more data sets acquired from a plurality of healthy structures.

6. The method as recited in claim 1, further including generating the anomaly detection threshold using the trained anomaly detector.

7. The method as recited in claim 1, wherein receiving a strain measurement includes receiving a strain measurement from a sensor coupled to a composite structure of a rotorcraft airframe.

8. The method as recited in claim 1, wherein generating a rating for the strain measurement includes selecting a rating from a continuous set of numerical ratings using the anomaly detector.

9. The method as recited in claim 1, wherein determining health of the structure of interest includes assigning a binary value to the strain measurement.

10. The method as recited in claim 1, further comprising determining strain at a location on the structure remote from the measurement location.

11. The method as recited in claim 1, wherein the received strain measurement is an output of a physics-based loads model.

12. The method as recited in claim 1, wherein the received strain measurement is an output of a virtual monitoring of loads model.

13. A structural diagnostic system, comprising a processor and a memory having program instructions for detecting anomalous strain response in a structure of interest, the program instructions being executable by the processor to cause:
receiving, by the processor, an anomaly detector;
receiving, by the processor, an anomaly detection threshold;
receiving, by the processor, a strain measurement for a structure of interest;
generating, by the processor, a rating for the strain measurement using the anomaly detector;
comparing, by the processor, the rating with the anomaly detection threshold; and
determining, by the processor, health of the structure of interest based on the comparison of the rating and the anomaly detection threshold.

14. The structural diagnostic system as recited in claim 13, wherein the program instructions are further executable by the processor to cause:
training the anomaly detector using a strain measurement training data set acquired from a plurality of healthy structures, wherein the strain measurement training data set comprising (a) loads training data set acquired from a plurality of healthy structures, (b) a state parameters training data set acquired from the plurality of healthy structures, and (c) a loads parameters training data set acquired from the plurality of healthy structures.

15. The structural diagnostic system as recited in claim 13, wherein the program instructions are further executable by the processor to cause generating, by the processor, the anomaly detection threshold using the trained anomaly detector.

16. The structural diagnostic system as recited in claim 13, further including a sensor coupled to a structure of interest and communicative with the processor, wherein the structure of interest is a composite structure of a rotorcraft airframe.

17. A structural diagnostic system as recited in claim 13, wherein the program instructions are further executable by the processor to cause, by the processor, selecting a rating from a continuous set of numerical ratings using the prediction model.

18. A structural diagnostic system as recited in claim 13, wherein the program instructions are further executable by the processor to cause, by the processor, assigning a binary value to the strain measurement.
